(19) United States
(12) Patent Application Publication
(10) Pub. No.: US 2006/0050096 A1
(43) Pub. Date: Mar. 9, 2006

(54) Ink ejection method, ink ejection apparatus, and image forming apparatus comprising same

(75) Inventor: Yuhei Chiwata, Ashigara-Kami-Gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/216,143

(22) Filed: Sep. 1, 2005

(30) Foreign Application Priority Data
Sep. 3, 2004 (JP) 2004-257588

(51) Int. Cl. B41J 29/38

(52) U.S. Cl. 347/5

(57) ABSTRACT

The ink ejection apparatus comprises: a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of the respective colors on the recording medium according to a prescribed stripe pattern, wherein among absolute values of stripe angles formed by the inks of the colors with respect to a direction of the relative movement of the recording medium, the absolute value of the stripe angle formed by the ink of yellow is set to be a minimum.

### BACKGROUND OF THE INVENTION

1. Field of the Invention

The present invention relates to an ink ejection method, an ink ejection apparatus, and an image forming apparatus comprising same, and more particularly to an image forming technology which uses a stripe pattern for the arrangement of dots formed by ejected inks of respective colors.

2. Description of the Related Art

Conventionally, as an image forming apparatus, an inkjet recording apparatus (inkjet printer) is known, which comprises an ink ejection apparatus (liquid ejection apparatus) including an inkjet head (ink ejection head) having an arrangement of a plurality of nozzles (liquid ejection ports) and which records images on a recording medium by ejecting ink from the nozzles toward the recording medium while causing the inkjet head and the recording medium to move relatively to each other.

In an inkjet recording apparatus of this kind, an image is created by means of a plurality of dots formed by ink droplets ejected onto a recording medium. Therefore, basically, an image is formed by binary data, in which a dot is either present (on: 1s) or not present (off: 0s) on a recording medium, such as white paper, for example. Furthermore, since the number of inks used is limited, various methods have been used in the prior art in order to form a tonally graduated image with those limited inks.

For example, as methods for representing tonal graduations by means of binary data, a dot representation (dot screen) is known which represents tonal graduations by changing the size of the dots, and a stripe representation (stripe screen or line screen) is also known which represents tonal graduations by changing the width (thickness) of a plurality of straight lines (stripes) disposed at equidistant intervals, at a uniform angle of inclination.

In a conventional inkjet recording apparatus, there is a problem in that “banding” (stripe-shaped non-uniformity) is liable to occur, due to errors in the paper feed operation, variations in the nozzles, or the like. In a so-called shuttle scanning type inkjet recording apparatus, it is possible to reduce “banding” in the main scanning direction by means of a “shingling” operation in which the dots in one row in the main scanning direction are printed in a plurality of actions by means of different nozzles.

However, a full-line head which covers the entire width of the paper so as to be able to record an image over the entire surface of the recording paper by performing one operation of conveying the recording paper and the print head relatively to each other (namely, a single-pass operation), is liable to cause the banding in the paper conveyance direction due to variations between nozzles. Therefore, since it is not possible to perform shingling as described above, there is a necessity to resolve the problem of banding in the paper conveyance direction.

In the inkjet recording apparatus, the extent of banding of this kind is related closely to the arrangement of the dots ejected onto the recording medium, and the aforementioned striping (line screen) method is known to be a dot arrangement which is resistant to banding.

As described above, the stripes are constituted essentially by a plurality of straight lines (stripes) arranged equidistantly at a uniform gradient, and a line pattern thereof arranged at a uniform frequency, so-called the number of lines (lines per inch or lpi), is based on a dot arrangement pattern in proper alignment.

Furthermore, when representing tonal graduations by means of stripes, density graduations are represented by altering the thickness of the respective lines constituting the stripes, as shown in FIGS. 14A to 14D. More specifically, FIG. 14A shows a case in which a stripe is constituted by aligning dots in one row; FIG. 14B shows a case in which respective lines are each formed by two rows of dots; and FIG. 14C shows a case in which respective lines are each formed by three rows dots; thereby enhancing the density graduation by increasing the number of dots constituting each line and thus gradually raising the thickness of the lines. Additionally, FIG. 14D shows a full solid image in which the respective lines join together.

In the single-pass full-line head such as described above, consideration is given to banding in the paper conveyance direction, which is a serious problem in this type of head.

FIGS. 15A to 15E show the relationship between various types of dot arrangements and the banding in the paper conveyance direction which occurs due to a variation relating to the nozzle, and the like. In FIGS. 15A to 15E, the paper conveyance direction is a direction from left hand to right hand shown as the arrows in the drawing.

FIG. 15A shows a case of adopting a Bayer dithering method. In this case, since the banding S1 in the paper conveyance direction is clearly visible, it is found that a dot arrangement by the Bayer dithering method is liable to cause the banding in the paper conveyance direction.

FIG. 15B shows a case of halftone dot dithering method. In this case, since the banding S2 in the paper conveyance direction is also clearly visible, it is found that a dot arrangement based on halftone dot dithering is liable to cause the banding in the paper conveyance direction.

FIG. 15C shows a case of a stripe pattern (lateral stripes) arranged at the same angle as the paper conveyance direction (a 0-degree angle with respect to the paper conveyance direction). In this case, since the striping S3 in the paper conveyance direction is also clearly discernable, it is found that a stripe pattern at a 0-degree angle is liable to cause the striping in the paper conveyance direction.

In this way, in the case of a dot arrangement pattern according to the paper conveyance direction, the banding in the paper conveyance direction is extremely conspicuous in synchronization with positional displacement of the dots. Hereinafter, a term “basic arrangement” is a fully aligned dot arrangement pattern, as described above.

On the other hand, the banding is decreased by a pattern which does not have a basic arrangement aligned with the paper conveyance direction, but rather has a basic arrangement aligned with a direction different to the direction which the banding occurs.

For example, FIG. 15D shows a case of a stripe pattern (vertical line screen) arranged at a perpendicular angle with respect to the paper conveyance direction (a 90-degree angle with respect to the paper conveyance direction). In this case, the banding S4 in the paper conveyance direction is not particularly conspicuous. Incidentally, FIGS. 15A to 15E are enlarged views, and the banding S4 in FIG. 15D appears to be equally visible as the banding in the other drawings. However, in a real-size pattern formed by ejecting inkjet dots, it is found that a stripe pattern having a 90-degree angle is resistant to the banding in the paper conveyance direction.

Furthermore, an isotropic pattern which does not have a uniform basic arrangement lies between the two types of pattern described above. For example, FIG. 15E shows a case in which the banding S5 in the paper conveyance direction occurs when using a blue noise mask (generally created so that it is not anisotropic). In this way, other types of patterns which do not have a uniform basic arrangement include patterns made by error diffusion method.

For example, a line screen (stripe pattern) which is perpendicular to the paper conveyance direction is effective on the banding in the paper conveyance direction. Therefore, conventionally, various technologies using a striping method have been suggested in order to improve image quality.

For example, in order to resolve the problem that the image dust in the digital photograph caused by the scattered toner's dust or the like spreads in parallel with the conveyance direction of the recording material in the image forming apparatus, a method is known in which a line screen is formed as a lateral line screen which is perpendicular to the conveyance direction of the recording material so as to improve image quality in response to such image dust (see Japanese Patent Application Publication No. 10-207172, for example).

For example, a method is also known in which a (striped) component perpendicular to the main scanning direction is added to the threshold value matrix used for error diffusion method as the method adopted for representing tonal graduation, so that non-uniform pitch of an image in the sub-scanning direction caused by non-uniform pitch of a printer is reduced (see Japanese Patent Application Publication No. 11-215376, for example).

Furthermore, for example, a method is also known in which a sub-matrix and a main matrix are comprised in the threshold value matrix used for converting image data inputted as multiple-value data into a dot arrangement of a smaller number of values and those matrices having a similarly shaped basic arrangement of oblique stripes, thereby obtaining uniform effects with respect to non-uniformities (variations) in both the main scanning direction and the sub-scanning direction, and improving image quality at low image resolution (see Japanese Patent Application Publication No. 2004-15674, for example).

Moreover, for example, a method is also known in which a density region of reduced line number is selected in a threshold value matrix (dithering matrix), and the dots in the matrix between respective densities is arranged so as to have high-pass filter characteristics and a basic stripe arrangement in a prescribed direction, thereby preventing degradation of image quality due to loss of continuity in the tonal graduation as a result of reducing the number of lines in a matrix pattern (see Japanese Patent Application Publication No. 2004-80065, for example).

However, if using a regular dot arrangement such as a striped arrangement, there is a problem that moiré effects occur when a color image is formed by ejecting inks of respective colors from heads of respective colors. More specifically, if the directions of stripes of the respective colors, such as cyan (C), magenta (M), yellow (Y), and black (K) (namely, the angle of the stripes from the paper conveyance direction) are set to the same direction, then interference between the respective colors may occur due to the occurrence of slight angular displacement caused by the inclination of the heads, or the like. Therefore, as that shown in FIG. 16, since a low-frequency striping (a moiré pattern) occurs, there is a marked problem in terms of image quality.

In Japanese Patent Application Publication Nos. 10-207172, 11-215376, 2004-15674, and 2004-80065, there is no disclosed technology for resolving the problem of moiré patterns of this kind.

In a single-pass type full-line head which records images onto the full surface of the recording paper by performing one operation of moving the recording paper and the head relatively to each other, the banding aligned in the paper conveyance direction occurs mainly, and there is little problem that the banding in the direction perpendicular to the paper conveyance direction (sub-scanning direction) occurs. Therefore, it is desirable to perform a dot arrangement which is most resistant to the banding (least liable to cause the banding) in the paper conveyance direction.

However, in Japanese Patent Application Publication Nos. 2004-15674 and 2004-80065, since the image forming apparatus has a composition in which errors occurring in the main scanning direction and sub-scanning direction caused by shuttle scanning are absorbed equally, there is a problem that the banding in the paper conveyance direction can not be resolved by a single-pass type full-line head such as described above.

### SUMMARY OF THE INVENTION

The present invention is contrived in view of such circumstances, and an object thereof is to provide an ink ejection method, an ink ejection apparatus, and an image forming apparatus comprising same which can reduce moiré effects during recording color image, while keeping the perceptibility of banding low.

In order to attain the aforementioned object, the present invention is directed to an ink ejection apparatus comprising: a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of the respective colors on the recording medium according to a prescribed stripe pattern, wherein among absolute values of stripe angles formed by the inks of the colors with respect to a direction of the relative movement of the recording medium, the absolute value of the stripe angle formed by the ink of yellow is set to be a minimum.

According to the present invention, since the absolute value of the stripe angle of the yellow ink, which has the lowest perceptibility of the respective colors, is set to a minimum, it is possible to suppress the banding in relative movement direction of recording medium and the occurrence of moiré patterns, due to occurring a variation in nozzle positions which is highly conspicuous by single-pass printing, a variation in the ink flight directions, and a variation in dot diameters.

In order to attain the aforementioned object, the present invention is also directed to an ink ejection apparatus comprising: a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of respective colors on the recording medium according to a prescribed stripe pattern, wherein among absolute values of stripe angles formed by the inks of the colors with respect to a direction of the relative movement of the recording medium, the absolute value of the stripe angle formed by the ink of magenta is set to be a maximum.

According to the present invention, since the absolute value of the stripe angle θ (M) of the magenta ink which has the highest perceptibility of the cyan ink, the magenta ink, and the yellow ink, is set to a maximum, it is possible to reduce the occurrence of banding in the relative movement direction of recording medium and the occurrence of moir\acute{e} patterns.

The present invention is also directed to the ink ejection apparatus wherein an angular difference between any pair of the stripe angles is 30° or greater.

Accordingly, it is possible to suppress the occurrence of moiré patterns effectively.

In order to attain the aforementioned object, the present invention is directed to an ink ejection apparatus comprising: a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of respective colors on the recording medium according to a prescribed stripe pattern, wherein a stripe angle formed by one of the colors is set so as to be greater than stripe angles formed by others of the colors with respect to a direction of the relative movement of the recording medium, the one of the colors being printed in the most quantity in intermediate density areas with respect to the direction of the relative movement of the recording medium.

The present invention is also directed to the ink ejection apparatus wherein the intermediate density areas are areas in which a perceived density is substantially 0.8.

According to the present invention, it is possible to suppress the occurrence of banding in the relative movement direction of the recording medium and the occurrence of moiré patterns, due to variation in the nozzle positions which is highly conspicuous during single-pass printing, a variation in the ink flight directions, and a variation in the dot diameters. Therefore, it is possible to print under optimal conditions for each respective image.

In order to attain the aforementioned object, the present invention is directed to an image forming apparatus comprising an ink ejection apparatus which comprises: a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of the respective colors on the recording medium according to a prescribed stripe pattern, wherein among absolute values of stripe angles formed by the inks of the colors with respect to a direction of the relative movement of the recording medium, the absolute value of the stripe angle formed by the ink of yellow is set to be a minimum.

In order to attain the aforementioned object, the present invention is directed to an image forming apparatus comprising an ink ejection apparatus which comprises: a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of respective colors on the recording medium according to a prescribed stripe pattern, wherein among absolute values of stripe angles formed by the inks of the colors with respect to a direction of the relative movement of the recording medium, the absolute value of the stripe angle formed by the ink of magenta is set to be a maximum.

The present invention is also directed to the image forming apparatus wherein an angular difference between any pair of the stripe angles is 30° or greater.

In order to attain the aforementioned object, the present invention is directed to an image forming apparatus comprising an ink ejection apparatus which comprises: a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of respective colors on the recording medium according to a prescribed stripe pattern, wherein a stripe angle formed by one of the colors is set to be greater than stripe angles formed by others of the colors with respect to a direction of the relative movement of the recording medium, the one of the colors being printed in the most quantity in intermediate density areas with respect to a direction of the relative movement of the recording medium.

The present invention is also directed to the image forming apparatus wherein the intermediate density areas are areas in which a perceived density is substantially 0.8.

According to present invention, it is possible to record images which reduce the banding in the relative movement direction of recording medium and the moiré effects.

Similarly, in order to attain the aforementioned object, the present invention is directed to an ink ejection method for recording a color image onto a recording medium comprising the steps of: moving at once relatively the recording medium and a plurality of ink ejection heads corresponding to colors which form the color image; ejecting respective inks of the colors from a plurality of nozzles comprised in the ink ejection heads toward the recording medium; and setting dot arrangements for the respective colors on the recording medium according to a prescribed stripe pattern so that among absolute values of stripe angles formed by the inks of the colors with respect to a direction of the relative movement of the recording medium, the absolute value of the stripe angle formed by the ink of yellow is set to be a minimum.

According to the present invention, it is possible to suppress the occurrence of banding in the relative movement direction of recording medium and the occurrence of moiré patterns, due to variation in the nozzle positions which is highly conspicuous during single-pass printing, a variation in the ink flight directions, and a variation in the dot diameters.

Furthermore, in order to attain the aforementioned object, the present invention is directed to an ink ejection method for recording a color image onto a recording medium comprising the steps of: moving at once relatively the recording medium and a plurality of ink ejection heads corresponding to colors which form the color image; ejecting respective inks of the colors from a plurality of nozzles comprised in the ink ejection heads toward the recording medium; and setting dot arrangements for the respective colors on the recording medium according to a prescribed stripe pattern so that among absolute values of stripe angles formed by the inks of the colors with respect to a direction of the relative movement of the recording medium, the absolute value of the stripe angle formed by the ink of magenta is set to be a maximum.

According to the present invention, it is possible to reduce the occurrence of banding in the relative movement direction of recording medium and the occurrence of moiré patterns.

The present invention is also directed to the ink ejection method wherein an angular difference between any pair of the stripe angles is 30° or greater.

Accordingly, it is possible to suppress the occurrence of moiré patterns effectively.

In order to attain the aforementioned object, the present invention is directed to an ink ejection method for recording a color image onto a recording medium comprising the steps of: moving at once relatively the recording medium and a plurality of ink ejection heads corresponding to colors which form the color image; ejecting respective inks of the colors from a plurality of nozzles comprised in the ink ejection heads toward the recording medium; and setting dot arrangements for the respective colors on the recording medium according to a prescribed stripe pattern so that a stripe angle formed by one of the colors which is printed in the greatest quantity in intermediate density areas with respect to a relative direction of moving the recording medium at the moving step is set to be greater than stripe angles formed by others of the colors with respect to the relative direction of moving the recording medium at the moving step.

In addition, the present invention is also directed to the image forming apparatus wherein the intermediate density areas are areas in which a perceived density is substantially 0.8.

According to the present invention, it is possible to suppress the occurrence of banding in the relative movement direction of recording medium and the occurrence of moiré patterns, due to a variation in the nozzle positions which is highly conspicuous during single-pass printing, a variation in the ink flight directions, a variation in the dot diameters. Therefore, it is possible to print under optimal conditions for each respective image.

As described above, according to the present invention, when recording color images, it is possible to reduce the moiré effects while maintaining low perceptibility of banding in the relative movement direction of recording medium.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus as an image forming apparatus according to an embodiment of the present invention;

FIG. 2 is a plan view of the principal part of the peripheral area of a printing unit in the inkjet recording apparatus shown in FIG. 1;

FIG. 3 is a plan perspective diagram showing an example of the structure of a print head;

FIG. 4 is a plan view showing a further example of a print head;

FIG. 5 is a cross-sectional view along line 5-5 in FIG. 3;

FIG. 6 is a schematic drawing showing the composition of an ink supply system in the inkjet recording apparatus according to the embodiment;

FIG. 7 is a partial block diagram showing the system composition of the inkjet recording apparatus according to the embodiment;

FIG. 8 is a plan diagram showing an example of a stripe pattern;

FIGS. 9A and 9B are diagrams showing a relationship between frequency vectors of two stripes and a frequency vector of a moiré component;

FIG. 10 is a graph showing a relationship between an angular difference along stripes and a moiré frequency;

FIG. 11 is a diagram showing a droplet deposition lattice for a line screen pattern having a stripe angle of 90°;

FIG. 12 is a diagram showing a droplet deposition lattice for a line screen pattern having a stripe angle of 45°;

FIG. 13 is a diagram showing a droplet deposition lattice for a line screen pattern having a stripe angle of 75°;

FIGS. 14A to 14D are illustrative diagrams showing a method for representing tonal graduations by means of stripes;

FIGS. 15A to 15E are illustrative diagrams showing a relationship between various dot arrangements and a banding in the paper conveyance direction; and

FIG. 16 is a diagram showing an aspect of a moiré pattern.

### DETAILED DESCRIPTION OF THE PREFERRED EMBODIMENTS

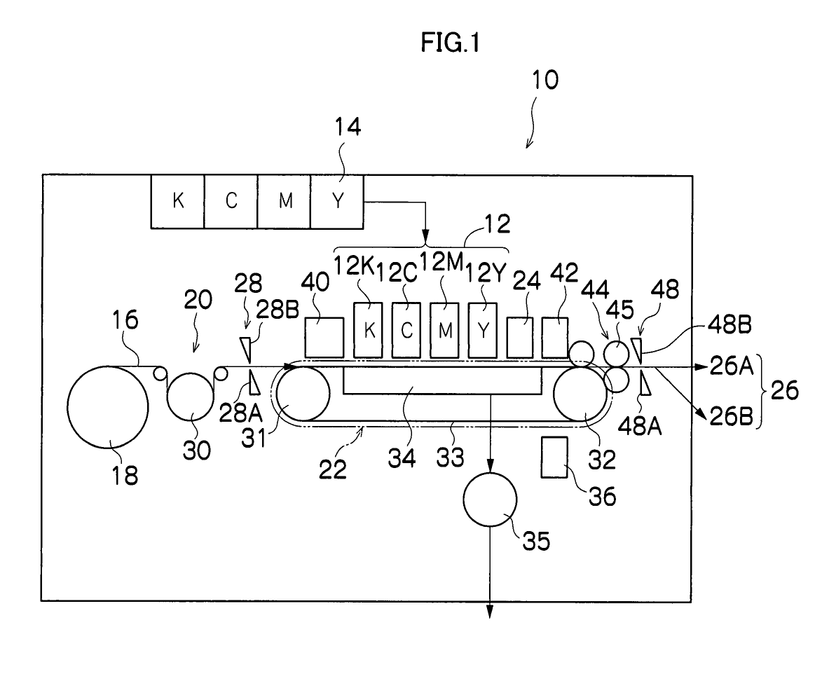

FIG. 1 is a general schematic drawing of an inkjet recording apparatus as an image forming apparatus according to an embodiment of the present invention.

As shown in FIG. 1, the inkjet recording apparatus 10 comprises: a printing unit 12 having a plurality of print heads (liquid ejection heads) 12K, 12C, 12M, and 12Y for ink colors of black (K), cyan (C), magenta (M), and yellow (Y), respectively; an ink storing and loading unit 14 for storing inks of K, C, M and Y to be supplied to the print heads 12K, 12C, 12M, and 12Y; a paper supply unit 18 for supplying recording paper 16; a decurling unit 20 for removing curl in the recording paper 16 supplied from the paper supply unit 18; a belt conveyance unit 22 disposed facing the nozzle face (ink-droplet ejection face) of the printing unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which roll paper is used, a cutter 28 is provided as shown in FIG. 1, and the roll paper is cut to a desired size by the cutter 28. The cutter 28 has a stationary blade 28A, of which length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyance path. When cut paper is used, the cutter 28 is not required.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

The decurled and cut recording paper 16 is delivered to the belt conveyance unit 22. The belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1. The suction chamber 34 provides suction with a fan 35 to generate a negative pressure, and the recording paper 16 on the belt 33 is held by suction.

The belt 33 is driven in the clockwise direction in FIG. 1 by the motive force of a motor (not shown) being transmitted to at least one of the rollers 31 and 32, which the belt 33 is set around, and the recording paper 16 held on the belt 33 is conveyed from left to right in FIG. 1.

Since ink adheres onto the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can comprise a roller nip conveyance mechanism, in which the recording paper 16 is pinched and conveyed with nip rollers, instead of the belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the belt conveyance unit 22. The heating fan 40 blows heated air onto the recording paper 16 to heat the recording paper 16 immediately before printing so that the ink deposited on the recording paper 16 dries more easily.

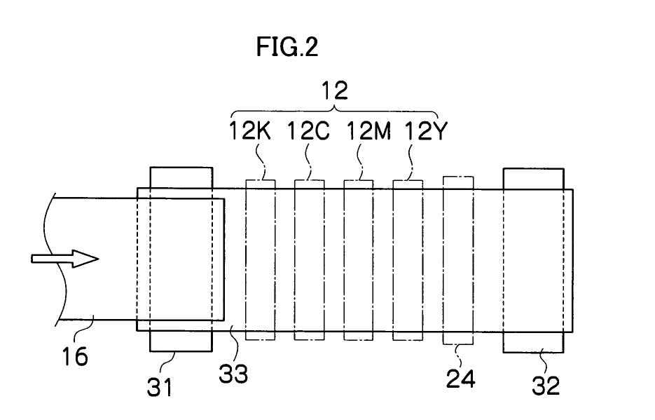

FIG. 2 is a principal plan diagram showing the periphery of the printing unit 12 in the inkjet recording apparatus 10.

As shown in FIG. 2, the printing unit 12 is a so-called “full line head” in which a line head having a length corresponding to the maximum paper width is arranged in a direction (main scanning direction) that is perpendicular to the paper conveyance direction (sub-scanning direction).

The print heads 12K, 12C, 12M and 12Y are constituted by full line heads in which a plurality of ink ejection ports (nozzles) are arranged through a length exceeding at least one side of the maximum size recording paper 16 intended for use with the inkjet recording apparatus 10.

The print heads 12K, 12C, 12M, 12Y corresponding to respective ink colors are disposed in the order, black (K), cyan (C), magenta (M) and yellow (Y), from the upstream side (left-hand side in FIG. 1), following the direction of conveyance of the recording paper 16 (the paper conveyance direction). A color print can be formed on the recording paper 16 by ejecting the inks from the print heads 12K, 12C, 12M, and 12Y, respectively, onto the recording paper 16 while conveying the recording paper 16.

The printing unit 12, in which full-line heads covering the entire width of the paper are thus provided for each of the respective ink colors, can record an image over the entire surface of the recording paper 16 by performing a single pass, namely, one action of moving the recording paper 16 and the printing unit 12 relatively to each other in the paper conveyance direction (sub-scanning direction) (in other words, by means of a single sub-scan). Higher-speed printing is thereby made possible and productivity can be improved in comparison with a shuttle type head configuration in which a recording head moves reciprocally in a direction (main scanning direction) which is perpendicular to the paper conveyance direction (sub-scanning direction).

Here, the terms “main scanning direction” and “sub-scanning direction” are used in the following senses. More specifically, in a full-line head comprising rows of nozzles that have a length corresponding to the entire width of the recording paper, “main scanning” is defined as printing one line (a line formed of a row of dots, or a line formed of a plurality of rows of dots) in the breadthways direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the blocks of the nozzles from one side toward the other. The direction indicated by one line recorded by a main scanning action (the lengthwise direction of the band-shaped region thus recorded) is called the “main scanning direction”.

On the other hand, “sub-scanning” is defined as to repeatedly perform printing of one line (a line formed of a row of dots, or a line formed of a plurality of rows of dots) formed by the main scanning, while moving the full-line head and the recording paper relatively to each other. The direction in which sub-scanning is performed is called the sub-scanning direction. Consequently, the conveyance direction of the reference point is the sub-scanning direction and the direction perpendicular to same is called the main scanning direction.

Although the configuration with the KCMY four standard colors is described in the present embodiment, combinations of the ink colors and the number of colors are not limited to those. Light inks or dark inks can be added as required. For example, a configuration is possible in which print heads for ejecting light-colored inks such as light cyan and light magenta are added. Furthermore, there are no particular restrictions of the sequence in which the heads of respective colors are arranged.

As shown in FIG. 1, the ink storing and loading unit 14 has tanks for storing inks of the colors corresponding to the respective print heads 12K, 12C, 12M and 12Y, and each tank is connected to a respective print head 12K, 12C, 12M, and 12Y, via a channel (not shown). Moreover, the ink storing and loading unit 14 also comprises notifying means (display means, alarm generating means, or the like) for generating a notification if the remaining amount of ink has become low, as well as having a mechanism for preventing incorrect loading of the wrong colored ink.

The print determination unit 24 has an image sensor for capturing an image of the ink-droplet deposition result of the printing unit 12, and functions as a device to check for ejection defects such as clogs of the nozzles in the printing unit 12 from the ink-droplet deposition results evaluated by the image sensor (line sensor).

The print determination unit 24 of the present embodiment is configured with at least a line sensor having rows of photoelectric conversion elements with a width that is greater than the ink-droplet ejection width (image recording width) of the print heads 12K, 12C, 12M, and 12Y. This line sensor has a color separation line CCD sensor including a red (R) sensor row composed of photoelectric conversion elements (pixels) arranged in a line provided with an R filter, a green (G) sensor row with a G filter, and a blue (B) sensor row with a B filter. Instead of a line sensor, it is possible to use an area sensor composed of photoelectric conversion elements which are arranged two-dimensionally.

The print determination unit 24 reads a test pattern image printed by the print heads 12K, 12C, 12M, and 12Y for the respective colors, and the ejection of each head is determined. The ejection determination includes the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, the paper output unit 26A for the target prints is provided with a sorter for collecting prints according to print orders.

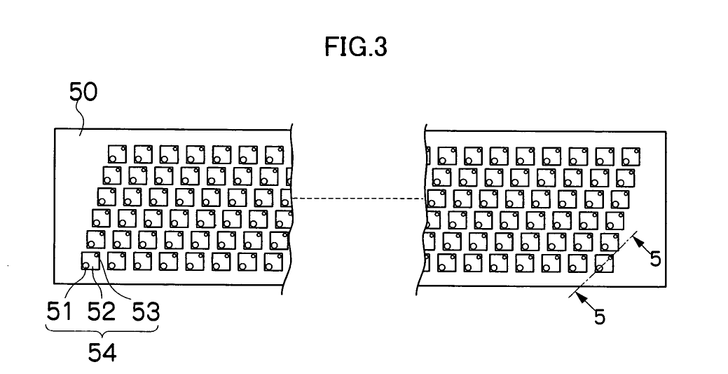

Next, the arrangement of nozzles (liquid ejection ports) in the print head (liquid ejection head) will be described. The print heads 12K, 12C, 12M and 12Y provided for the respective ink colors have the same structure, and a print head forming a representative example of these print heads 12K, 12C, 12M, and 12Y is indicated by the reference numeral 50. FIG. 3 shows a plan perspective diagram of the print head 50.

As shown in FIG. 3, the print head 50 according to the present embodiment achieves a high density arrangement of nozzles 51 by using a two-dimensional staggered matrix array of pressure chamber units 54, each constituted by a nozzle 51 for ejecting ink as ink droplets, a pressure chamber 52 for applying pressure to the ink in order to eject ink, and an ink supply port 53 for supplying ink to the pressure chamber 52 from a common flow channel (not shown in FIG. 3).

In the example shown in FIG. 3, each of the pressure chambers 52 has an approximately square planar shape when viewed from above, but the planar shape of the pressure chambers 52 is not limited to a square shape. As shown in FIG. 3, a nozzle 51 is formed at one end of the diagonal of each pressure chamber 52, and an ink supply port 53 is provided at the other end thereof.

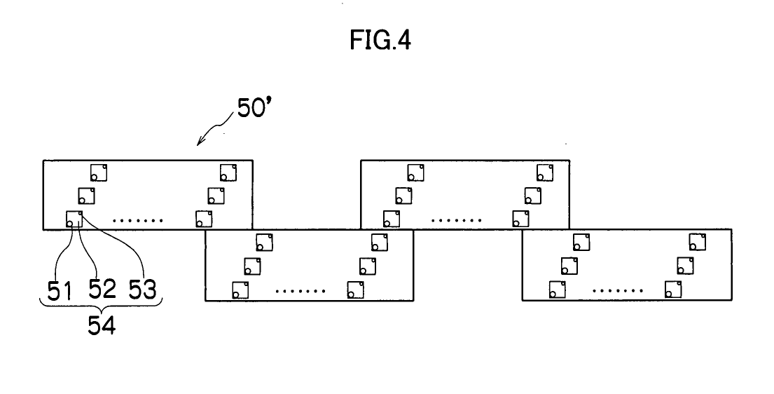

FIG. 4 is a plan perspective diagram showing a further example of the structure of a print head. As shown in FIG. 4, one long full line head may be constituted by combining a plurality of short heads 50′ arranged in a two-dimensional staggered array, in such a manner that the combined length of this plurality of short heads 50′ corresponds to the full width of the print medium.

FIG. 5 shows a cross-sectional view along line 5-5 in FIG. 3.

As shown in FIG. 5, each of the pressure chamber units 54 is formed by a pressure chamber 52 which is connected to a nozzle 51 that ejects ink, a common flow channel 55 for supplying ink via an ink supply port 53 is connected to the pressure chamber 52, and one surface of the pressure chamber 52 (the ceiling in the diagram) is constituted by a diaphragm 56. A piezoelectric element 58 which deforms the diaphragm 56 by applying pressure to the diaphragm 56 is bonded to the upper part of same, and an individual electrode 57 is formed on the upper surface of the piezoelectric element 58. Furthermore, the diaphragm 56 also serves as a common electrode.

The piezoelectric element 58 is sandwiched between the common electrode (diaphragm 56) and the individual electrode 57, and it deforms when a drive voltage is applied to these two electrodes 56 and 57. The diaphragm 56 is pressed by the deformation of the piezoelectric element 58, in such a manner that the volume of the pressure chamber 52 is reduced and ink is ejected from the nozzle 51. When the voltage applied between the two electrodes 56 and 57 is released, the piezoelectric element 58 returns to its original position, the volume of the pressure chamber 52 returns to its original size, and new ink is supplied into the pressure chamber 52 from the common flow channel 55 and via the supply port 53.

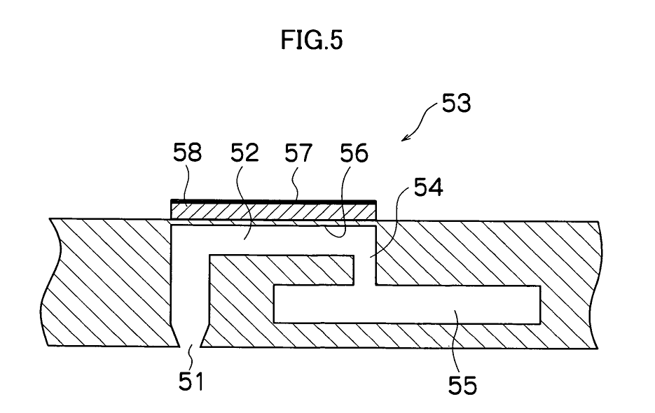

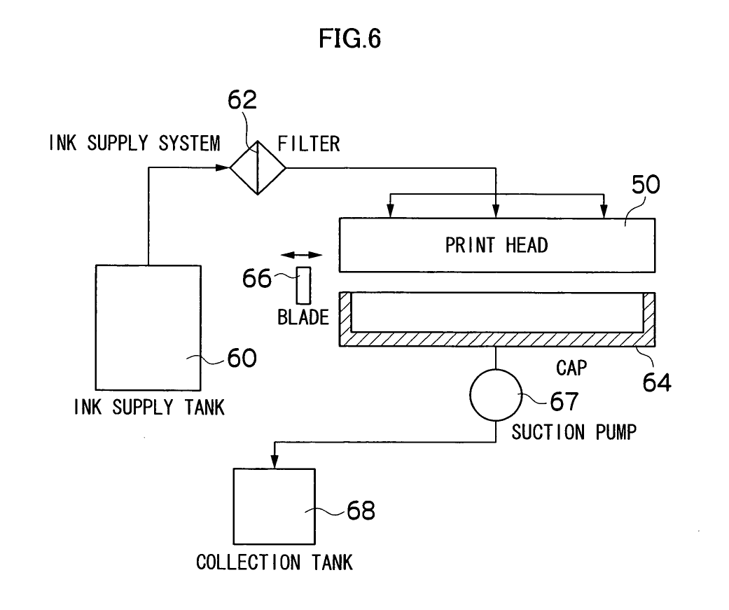

FIG. 6 is a schematic drawing showing the configuration of an ink supply system in the inkjet recording apparatus 10. The ink tank 60 is a base tank that supplies ink to the print head 50 and is set in the ink storing and loading unit 14 described with reference to FIG. 1. The aspects of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type. The ink tank 60 in FIG. 6 is equivalent to the ink storing and loading unit 14 in FIG. 1 described above.

As shown in FIG. 6, a filter 62 for eliminating foreign material and air bubbles is provided at an intermediate position of the channel which connects the ink tank 60 with the print head 50. Desirably, the filter mesh size is the same as the nozzle diameter in the print head 50, or smaller than the nozzle diameter (generally, about 20 μm).

Although not shown in FIG. 6, it is preferable to provide a sub-tank integrally to the print head 50 or nearby the print head 50. The sub-tank has a damper function for preventing variation in the internal pressure of the head and a function for improving refilling of the print head.

The inkjet recording apparatus 10 is also provided with a cap 64 as a device to prevent the nozzles from drying out or to prevent an increase in the ink viscosity in the vicinity of the nozzles 51, and a cleaning blade 66 as a device to clean the nozzle face 50A.

A maintenance unit including the cap 64 and the cleaning blade 66 can be relatively moved with respect to the print head 50 by a movement mechanism (not shown), and is moved from a predetermined holding position to a maintenance position below the print head 50 as required.

The cap 64 is displaced upwards and downwards in a relative fashion with respect to the print head 50 by an elevator mechanism (not shown). When the power of the inkjet recording apparatus 10 is switched off or when the apparatus is in a standby state for printing, the elevator mechanism raises the cap 64 to a predetermined elevated position so as to come into close contact with the print head 50, and the nozzle region of the nozzle face 50A is thereby covered by the cap 64.

The cleaning blade 66 is composed of rubber or another elastic member, and can slide on the ink ejection surface (nozzle surface 50A) of the print head 50 by means of a blade movement mechanism (not shown). If there are ink droplets or foreign matter adhering to the nozzle surface 50A, then the nozzle surface 50A is wiped by causing the cleaning blade 66 to slide over the nozzle surface 50A, thereby cleaning same.

During printing or during standby, if the use frequency of a particular nozzle 51 has declined and the ink viscosity in the vicinity of the nozzle 51 has increased, then a preliminary ejection is performed toward the cap 64, in order to remove the ink that has degraded as a result of increasing in viscosity.

Also, when bubbles have become intermixed in the ink inside the print head 50 (the ink inside the pressure chambers 52), the cap 64 is placed on the print head 50, ink (ink in which bubbles have become intermixed) inside the pressure chambers 52 is removed by suction with a suction pump 67, and the ink removed by suction is sent to a collection tank 68. This suction operation is also carried out in order to suction and remove degraded ink which has hardened due to increasing in viscosity when ink is loaded into the head for the first time, and when the head starts to be used after having been out of use for a long period of time.

When a state in which ink is not ejected from the print head 50 continues for a certain amount of time or longer, the ink solvent in the vicinity of the nozzles 51 evaporates and ink viscosity increases. In such a state, ink can no longer be ejected from the nozzle 51 even if the piezoelectric element 58 (see FIG. 5) for the ejection driving is operated. Before reaching such a state (in a viscosity range that allows ejection by the operation of the piezoelectric element 58) the piezoelectric element 58 is operated to perform the preliminary discharge to eject the ink of which viscosity has increased in the vicinity of the nozzle toward the ink receptor. After the nozzle face 50A is cleaned by a wiper such as the cleaning blade 66 provided as the cleaning device for the nozzle face 50A, a preliminary discharge is also carried out in order to prevent the foreign matter from becoming mixed inside the nozzles 51 by the wiper sliding operation. The preliminary discharge is also referred to as “dummy discharge”, “purge”, “liquid discharge”, and so on.

When bubbles have become intermixed into the nozzles 51 or the pressure chambers 52, or when the ink viscosity inside the nozzles 51 has increased beyond a certain level, ink can no longer be ejected by means of a preliminary ejection, and hence a suctioning action is carried out as described above.

More specifically, when bubbles have become intermixed into the ink inside the nozzles 51 and the pressure chambers 52, ink can no longer be ejected from the nozzles even if the piezoelectric elements 58 are operated. In a case of this kind, a cap 64 is placed on the nozzle surface 50A of the print head 50, and the ink containing air bubbles or the ink of increased viscosity inside the pressure chambers 52 is suctioned by a pump 67.

However, this suction action is performed with respect to all of the ink in the pressure chambers 52, and therefore the amount of ink consumption is considerable. Consequently, it is desirable that a preliminary ejection is carried out, whenever possible, while the increase in viscosity is still minor. The cap 64 described in FIG. 6 functions as a suctioning device and it may also function as an ink receptacle for preliminary ejection.

Moreover, desirably, the inside of the cap 64 is divided by means of partitions into a plurality of areas corresponding to the nozzle rows, thereby achieving a composition in which suction can be performed selectively in each of the demarcated areas, by means of a selector, or the like.

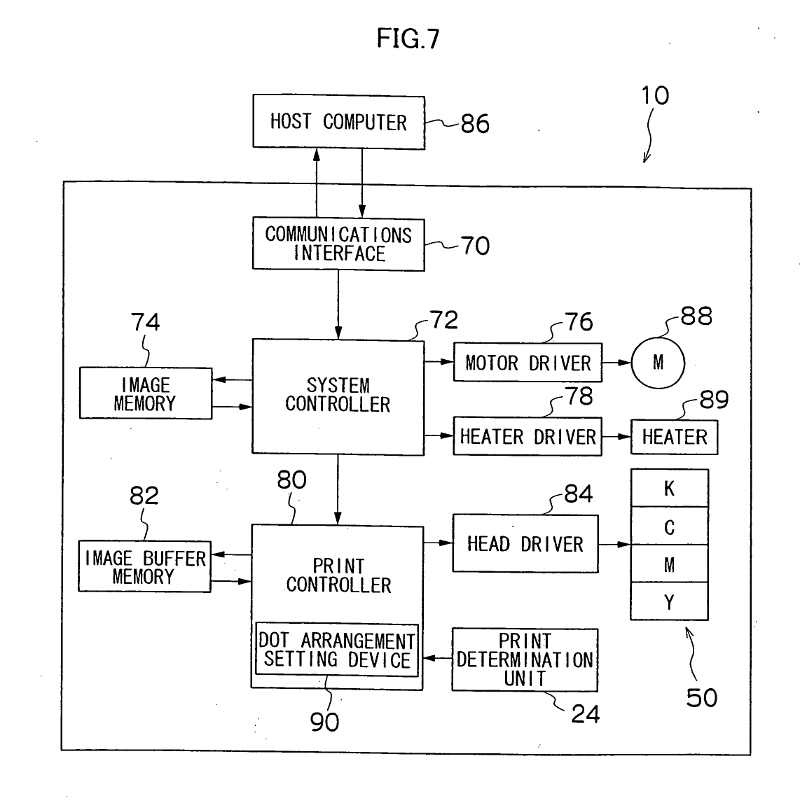

FIG. 7 is a principal block diagram showing a system configuration of the inkjet recording apparatus 10. The inkjet recording apparatus 10 comprises a communication interface 70, a system controller 72, an image memory 74, a motor driver 76, a heater driver 78, a print controller 80, an image buffer memory 82, a head driver 84, and the like.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is a control unit for controlling the various sections, such as the communications interface 70, the image memory 74, the motor driver 76, the heater driver 78, and the like. The system controller 72 is constituted by a central processing unit (CPU) and peripheral circuits thereof, and the like, and in addition to controlling communications with the host computer 86 and controlling reading and writing from and to the image memory 74, or the like, it also generates a control signal for controlling the motor 88 of the conveyance system and the heater 89.

The motor driver (drive circuit) 76 drives the motor 88 in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print control signal (print data) to the head driver 84. Prescribed signal processing is carried out in the print controller 80, and the ejection amount and the ejection timing of the ink droplets from the respective print heads 50 are controlled via the head driver 84, according to the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. The aspect shown in FIG. 7 is one in which the image buffer memory 82 accompanies the print controller 80; however, the image memory 74 may also serve as the image buffer memory 82. Also possible is an aspect in which the print controller 80 and the system controller 72 are integrated to form a single processor.

Furthermore, a dot arrangement setting device 90 is provided in the print controller 80, which sets dot arrangements which are optimal in terms of suppressing banding and moiré effects in the conveyance direction of the recording paper 16.

The head driver 84 drives the piezoelectric elements 58 of the print heads 50 of the respective colors according to the print data supplied by the print controller 80, in such a manner that dot arrangements set by the dot arrangement setting device 90 are obtained. Consequently, the ink droplets which are ejected onto the recording paper 16 form in dot arrangements which are set by the dot arrangement setting device 90. A feedback control system for maintaining constant drive conditions for the print heads may be included in the head driver 84.

The method of setting optimal dot arrangements for suppressing banding and moiré effects in the conveyance direction will be described below in detail.

The print determination unit 24 is a block that includes the line sensor (not shown) as described above with reference to FIG. 1, reads the image printed on the recording paper 16, determines the print conditions (presence of the ejection, variation in the dot formation, and the like) by performing desired signal processing, or the like, and provides the determination results of the print conditions to the print controller 80.

Furthermore, the print controller 80 makes various corrections with respect to the print head 50 according to information obtained from the print determination unit 24, as required.

The present embodiment causes a single-pass type full-line head to set dot arrangements which have a maximum effect in suppressing both banding in the paper conveyance direction and moiré patterns by using a stripe pattern, as described below in detail.

Desirably, the number of lines in the stripe pattern is high, in order to achieve good resolution and ensure that the stripe pattern itself is not discernable. In the present embodiment, it is supposed that the number of lines at which the perceptibility of the stripe patterns is reduced to a sufficiently low level is 300 lpi (lines per inch).

In the present embodiment, as described above, in order to print a color image, the print heads 50 (12K, 12C, 12M, and 12Y) are provided for ejecting inks of the respective colors, K, C, M, and Y, and as shown previously in FIG. 2, the print heads 12K, 12C, 12M, and 12Y are single-pass type full-line heads.

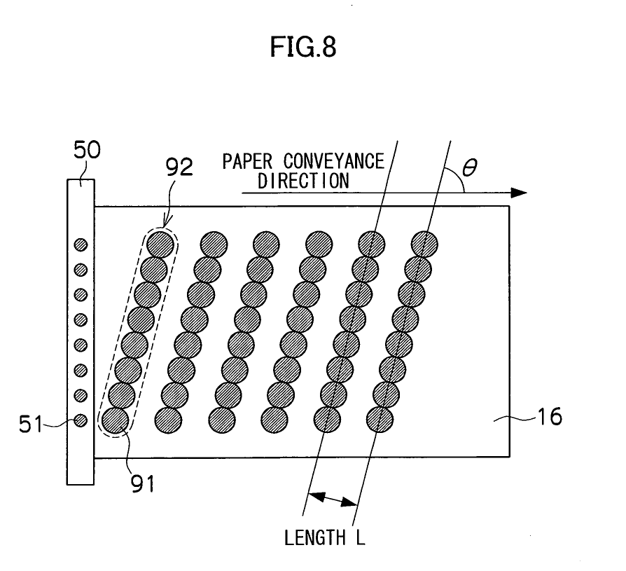

FIG. 8 shows an example of the stripe pattern. As shown in FIG. 8, the print head 50 is disposed in a direction perpendicular to the conveyance direction of the recording paper 16, and forms a plurality of dots 91 on the recording paper 16 by ejecting ink droplets from the nozzles 51 as well as the recording paper 16 is conveyed.

In this case, the droplet ejection timing is controlled by the print controller 80 so that the dots 91 are formed in the dot arrangement specified by the dot arrangement specification device 90 provided in the print controller 80, and hence the dots 91 on the recording paper 16 are formed in straight lines (stripes) 92.

The straight lines (stripes) 92 on the recording paper 16 are formed mutually in parallel, respectively at an angle θ with respect to the paper conveyance direction, and the distance between each of the straight lines 92 is a constant value L. Therefore, the stripe pattern is formed as a group of the parallel and equidistantly straight lines 92. In this case, the angle θ that the straight lines 92 is formed with respect to the paper conveyance direction is taken to be the stripe angle (stripe printing angle), and the number of lines (in lpi, i.e. in lines per inch) is taken to be the reciprocal l/L of the distance L between the straight lines.

As suggested FIG. 8, the angle θ of the stripes 92 has a meaningful range of −90°<θ≦90°.

When printing, there may be a case in which the stripe angle θ cannot be adjusted sufficiently by the low accuracy inclination of the print head 50. In this case, when inks of different colors are printed at the same stripe angle θ, a moiré pattern may occur if there is a slight divergence between the stripe angles θ of inks of two different colors, due to errors in the accuracy inclination of the respective print heads 50.

Consequently, in order to avoid the occurrence of a moiré pattern in cases such as these, it is desirable to adopt dot arrangements in which there is a sufficient angular difference between the stripe angles of the stripes 92 of two different colors. This is described below.

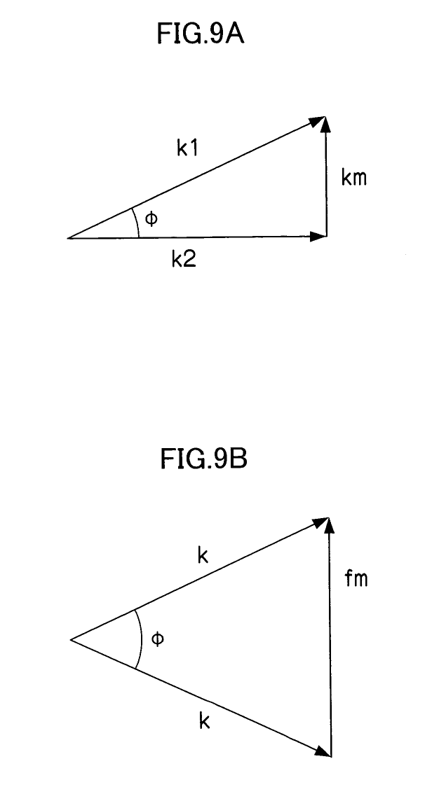

As shown in FIG. 9A, when a vector k1 and a vector k2 are the frequency vectors of two stripe patterns having different stripe angles θ so that an angular difference is φ, it is known that the frequency vector km of the moiré component is given by km=k1−k2.

Furthermore, in particular, when each the number of lines (frequency) in two stripe patterns is equal to k, and an angular difference is φ, the frequency fm of the moiré pattern can be shown with reference to FIG. 9B as a following equation (1):
fm=k·\sqrt{2·(1−cos φ)}. (1)

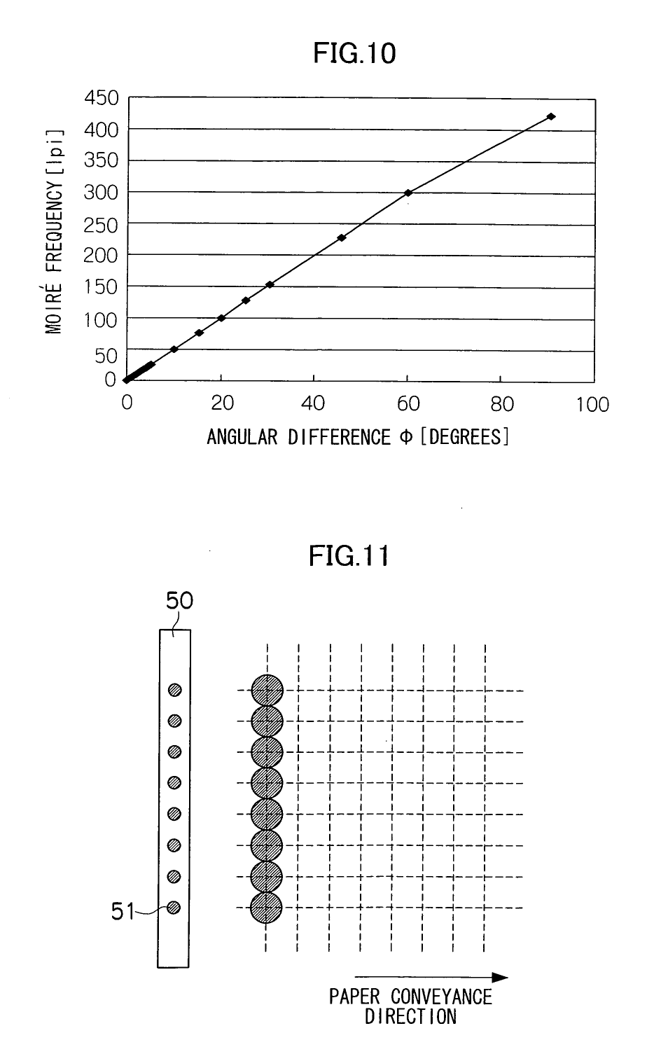

FIG. 10 shows a relationship between the angular difference φ between the two stripe patterns and the moiré frequency fm, when the frequency of the stripe patterns is 300 lpi.

In general, it is known that a moiré pattern is not highly noticeable when the frequency fm of the moiré pattern is 150 lpi or greater. In this case, as shown in FIG. 10, the angular difference φ between the two stripe patterns is preferably 30° or greater, in other words, φ≧30°. Moreover, it is also known that a moiré pattern is barely noticeable when the frequency fm of the moiré pattern is 200 lpi or greater. In this case, as shown in FIG. 10, the angular difference φ between the two stripe patterns is more preferably 45° or greater, in other words, φ≧45°.

Consequently, while maintaining the stripe angles θ of the respective colors within a range of −90°<θ≦90°, the angular difference φ between any two stripe patterns is set to the aforementioned conditions that the angular difference φ is 30° or greater, and more desirably, 45° or greater, and hence it is possible to reduce the moiré effects at a minimum.

Next, the reduction of banding in the paper conveyance direction will be described.

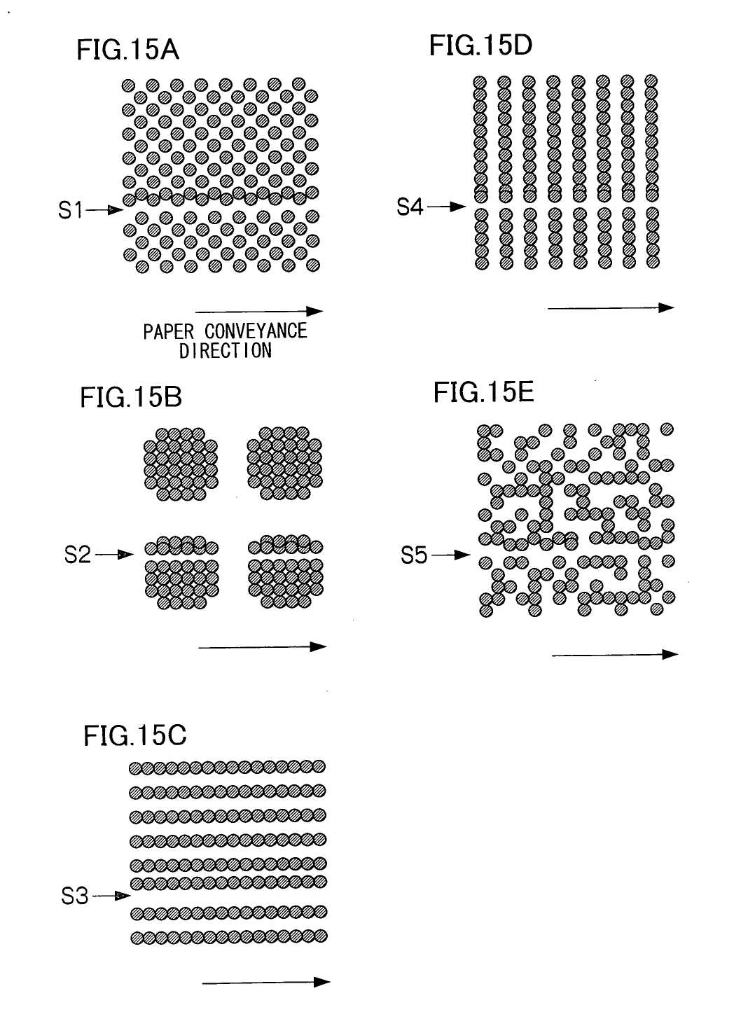

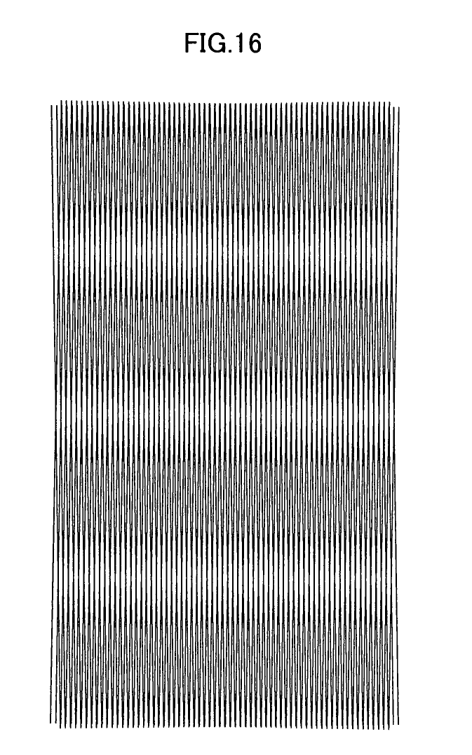

From the viewpoint of reducing banding in the paper conveyance direction, as shown in FIG. 15C, the nearer the stripe angle θ becomes to 0° (in other words, the closer the stripe direction comes to being parallel with the paper conveyance direction), the higher perceptibility of banding becomes (resistance to banding decreases). Therefore, it is desirable to set a stripe angle θ which reduces the moiré effects at a minimum while also reducing the perceptibility of banding at a minimum.

In this case, since the yellow ink Y has the lowest perceptibility of the respective colors, the banding is not readily perceptible even if there is a variation in the yellow dots. Therefore, it is desirable that the stripe angle θ (Y) of the yellow ink Y, including the stripe angles θ of the respective colors, is closest to zero. In other words, the absolute value |θ(Y)| of the stripe angle θ (Y) of the Y ink is desirably a minimum (as close as possible to 0°).

In addition, it is known that the banding is not readily perceptible in the vicinity of shadow areas (highest density areas) or highlight areas (lowest density areas), and that the banding is most readily perceptible in intermediate density areas (grey areas) that a perceived density D is substantially 0.8, in other words, a perceived density D is in the range of approximately 0.6 to 1.0.

Therefore, it is realized that banding in the paper conveyance direction can be reduced optimally by designing the head 50 so that the absolute value of the stripe angle θ is set to a maximum for the ink (excluding the yellow ink Y) which is the most amount of usage in the intermediate density area (grey area) that the perceived density D is substantially 0.8.

Furthermore, in intermediate density areas, the cyan, magenta, and yellow inks C, M and Y are generally used in greater volumes than the black ink K. In this case, when the black color is generated by UCR method (namely, under color removal method) so that the black ink K is substituted for grey components formed by overlapping the cyan, magenta, and yellow color components, the threshold level which is set for making the substitution determines which of the color inks have the most amount of usage.

Even though the ink which is the most amount of usage varies depending on this setting, the yellow ink Y has the lowest perceptibility as described previously, and hence the absolute value of the stripe angle θ of the color ink which is the most amount of usage in the intermediate density areas is set to be a maximum except for the yellow ink Y that the absolute value |θ(Y)| of the stripe angle is set to be a minimum.

Generally, the grey color in the intermediate density areas in the vicinity of D=0.8 is created by mixing the cyan, magenta, and yellow inks C, M and Y, rather than by using the black ink K. Furthermore, since the magenta ink M has the greatest perceptibility in the cyan, magenta, and yellow inks C, M and Y, the absolute value |θ(Y)| of the stripe angle θ (M) of the magenta ink M is desirably a maximum.

Subsequently, it is desirable that the absolute value |θ(C)| of the stripe angle θ(C) of the C (cyan) ink is greater than zero.

As described in the foregoing, in order to simultaneously reduce the occurrence of banding in the paper conveyance direction and the occurrence of moiré patterns, it is desirable to adopt a composition of the following kind, for example.

More specifically, first, the stripe angle θ (M) is set to be 90° so that the absolute value of angle θ (M) of the magenta ink M is a maximum. Next, the stripe angle θ (C) for the cyan ink C is set to be −45° and the stripe angle θ (K) for the black ink K is set to be 45° so that the stripe angles θ (K) and θ (C) are set to be greater than 0° while keeping the angular difference φ between the stripe angles θ of different inks to at least 30° or greater (desirably, 45° or greater). Then, as described previously, the angle θ (Y) is set to be 0° so that the absolute value of the stripe angle θ for the yellow ink Y is a minimum.

From the foregoing explanation, the absolute values of the stripe angles of the black, cyan, magenta, and yellow inks K, C, M, and Y is desirably set so as to establish a relationship shown as a following inequality (2):
|θ(Y)|≦|θ(K)|≦|θ(C)|≦|θ(M)|. (2)

The foregoing description has related to a case in which the stripe angle θ is not adjusted sufficiently by means of the inclination accuracy of the print head 50 which affects the accuracy of the stripe angle θ. However, if the sufficient adjustment is achieved by means of the inclination accuracy of the print head 50, then no moiré patterns occur even if the stripe angles θ of all of the inks K, C, M, and Y are set to be the same.

When the stripe angle is adjusted sufficiently by means of the inclination accuracy of the print head, then greatest resistance to banding in the paper conveyance direction is achieved when the stripe angles of all of the color inks are set to be 90°, shown as a following equation (3):
θ(C)=θ(M)=θ(Y)=θ(K)=90°. (3)

As described above, when forming actual dot arrangements on recording paper 16 in accordance with the stripe patterns having set stripe angles for each respective ink color, it is not possible to print a smooth line at a stripe angle θ other than 0°, 45°, or 90°, if the ejection timing of the dots (ink droplets) is restricted to timings conforming to a square lattice. Therefore, the ejection timings of the nozzles 51 are desirably adjusted in accordance with the stripe angle θ, in such a manner that smooth lines can be printed.

More specifically, since the stripe angle θ is set to be a different from each color, it is desirable to design the potential droplet deposited positions (referred to hereafter as “droplet deposition lattice”) for arranging the dots on the stripe by performing a half-tone process, so that droplets can be ejected to form smooth stripes when printing the stripe optimally.

For example, when the stripe angle θ of the magenta ink M is 90°, the droplet deposition lattice is desirably a rectangular (or square) shaped lattice as shown in FIG. 11.

The edges of the lattice shown as the broken lines in FIG. 11 indicate the positions (droplet deposition lattice) onto which dots can actually be deposited from the nozzles 51 of the print head 50. In this case, a stripe which is perpendicular to the paper conveyance direction shown as an arrow in FIG. 11 is formed by ejecting droplets simultaneously from the nozzles 51. Thereby, a dot arrangement is formed in a stripe pattern which is highly resistant to the banding in the paper conveyance direction.

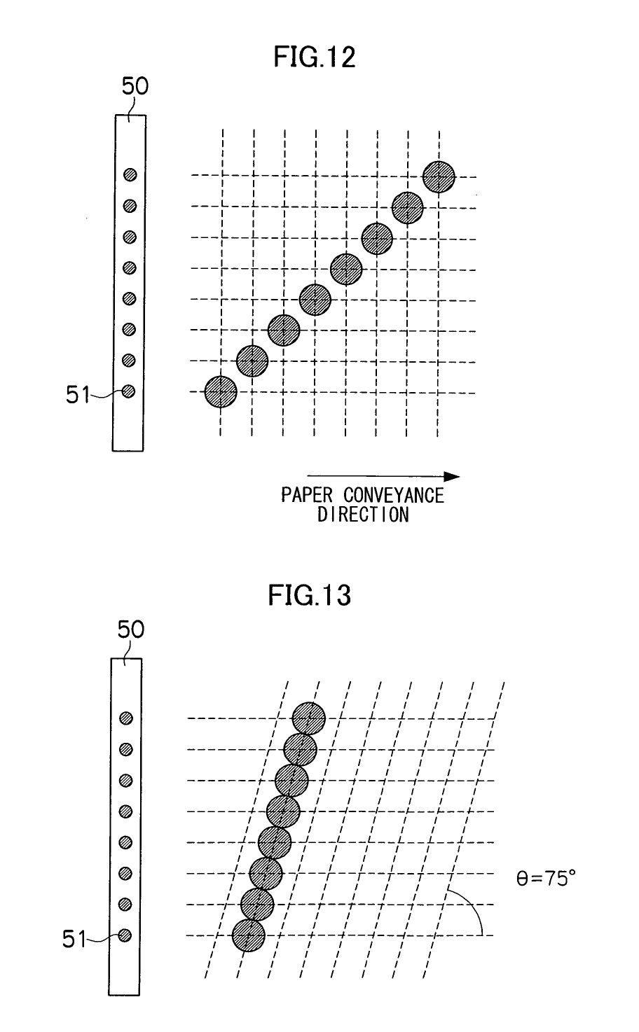

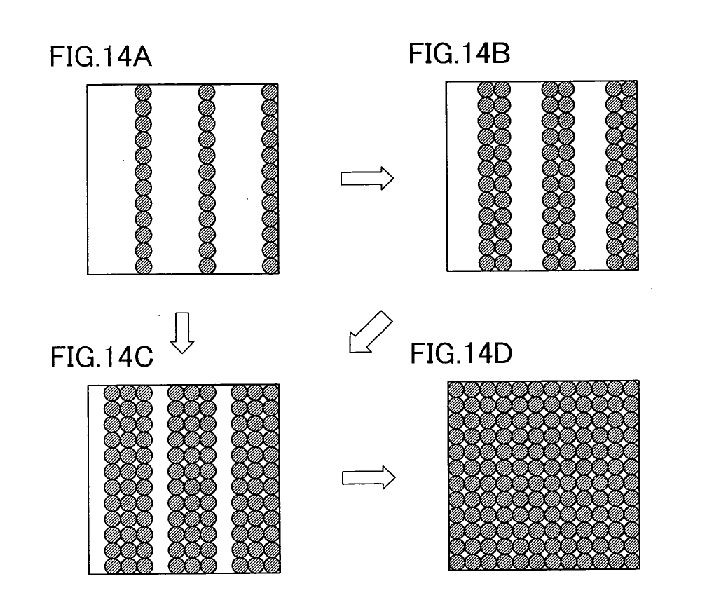

Furthermore, for example, when the stripe angle θ of the black ink K is set to be 45°, it is desirable that the droplet deposition lattice is a square-shaped lattice shown in FIG. 12. The lattice shown as the broken lines in FIG. 12 indicates the positions onto which dots can be deposited from the nozzles 51 of the print head 50. In this case, in order to form a stripe having a stripe angle of 45°, droplets should be ejected sequentially, one by one, from the nozzles 51.

Depending on the design, the stripe angle θ may be set to be 75°, at which droplets cannot be deposited optimally according to a rectangular droplet deposition lattice. In this case, as shown in FIG. 13, an optimal design for stripe printing can be achieved by adopting a parallelogram-shaped lattice in accordance with the set angle θ.

In addition, the aforementioned lattice designs can be achieved by adjusting the ejection timing at the respective nozzles, without making any modifications to the structure of the print head 50.

As described above, by setting a suitable dot arrangement, it is possible to reduce both the occurrence of banding in the paper conveyance direction and the occurrence of moiré effects. More specifically, a dot arrangement of this kind is designed by the dot arrangement setting device 90, and the print controller 80 controls the droplet ejection timings via the head driver 84 according to this set arrangement, in such a manner that dot arrangements having stripe patterns are formed as described above.

Furthermore, according to the present embodiment, the absolute value |θ(Y)| of the stripe angle θ of the yellow ink Y, which has the lowest perceptibility of the respective ink colors, is set to be a minimum, as well as the absolute value of the stripe angle of the color (except for the yellow ink Y) which is the most account of usage (used ink volume) in the intermediate density areas in the vicinity of D=0.8, is set to be a maximum. Therefore, it is possible to reduce moiré effects while keeping the perceptibility of banding in the paper conveyance direction low.

In particular, it is possible to obtain beneficial effects when the absolute value |θ(M)| of the stripe angle of the magenta ink M which has the highest perceptibility of the cyan, magenta, and yellow inks C, M, and Y, is set to be a maximum.

Moreover, it is possible to print smooth stripes by optically controlling the ejection timing in accordance with the stripe angle.

The ink ejection method, ink ejection apparatus, and image forming apparatus comprising same according to the present invention have been described above in detail, but the present invention is not limited to the aforementioned examples, and it is of course possible for improvements or modifications of various kinds to be implemented, within a range which does not deviate from the essence of the present invention.

In addition, the present invention is not limited to those which form images according to binary values, and it is also valid with respect to an image forming apparatus having a head capable of representing multiple values, such as ternary or quaternary values, by ejecting dots of several different sizes.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An ink ejection apparatus, comprising:
a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and
a dot arrangement setting device which sets each of dot arrangements of the inks of the respective colors on the recording medium according to a prescribed stripe pattern,
wherein among absolute values of stripe angles formed by the inks of the colors with respect to a direction of the relative movement of the recording medium, the absolute value of the stripe angle formed by the ink of yellow is set to be a minimum.

2. The ink ejection apparatus as defined in claim 1, wherein an angular difference between any pair of the stripe angles is 30° or greater.

3. An ink ejection apparatus, comprising:
a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and
a dot arrangement setting device which sets each of dot arrangements of the inks of respective colors on the recording medium according to a prescribed stripe pattern,
wherein among absolute values of stripe angles formed by the inks of the colors with respect to a direction of the relative movement of the recording medium, the absolute value of the stripe angle formed by the ink of magenta is set to be a maximum.

4. The ink ejection apparatus as defined in claim 3, wherein an angular difference between any pair of the stripe angles is 30° or greater.

5. An ink ejection apparatus, comprising:
a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and
a dot arrangement setting device which sets each of dot arrangements of the inks of respective colors on the recording medium according to a prescribed stripe pattern,
wherein a stripe angle formed by one of the colors is set so as to be greater than stripe angles formed by others of the colors with respect to a direction of the relative movement of the recording medium, the one of the colors being printed in the most quantity in intermediate density areas with respect to the direction of the relative movement of the recording medium.

6. The ink ejection apparatus as defined in claim 5, wherein the intermediate density areas are areas in which a perceived density is substantially 0.8.

7. An image forming apparatus, comprising an ink ejection apparatus which comprises:
a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of the respective colors on the recording medium according to a prescribed stripe pattern,
wherein among absolute values of stripe angles formed by the inks of the colors with respect to a direction of the relative movement of the recording medium, the absolute value of the stripe angle formed by the ink of yellow is set to be a minimum.

8. The image forming apparatus as defined in claim 7, wherein an angular difference between any pair of the stripe angles is 30° or greater.

9. An image forming apparatus, comprising an ink ejection apparatus which comprises:
a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of respective colors on the recording medium according to a prescribed stripe pattern,
wherein among absolute values of stripe angles formed by the inks of the colors with respect to a direction of the relative movement of the recording medium, the absolute value of the stripe angle formed by the ink of magenta is set to be a maximum.

10. The image forming apparatus as defined in claim 9, wherein an angular difference between any pair of the stripe angles is 30° or greater.

11. An image forming apparatus, comprising an ink ejection apparatus which comprises:
a plurality of ink ejection heads which are provided corresponding to a plurality of colors to record a color image onto a recording medium by performing one relative movement with respect to the recording medium, the ink ejection heads having a plurality of nozzles for ejecting respective inks of the colors toward the recording medium; and a dot arrangement setting device which sets each of dot arrangements of the inks of respective colors on the recording medium according to a prescribed stripe pattern,
wherein a stripe angle formed by one of the colors is set to be greater than stripe angles formed by others of the colors with respect to a direction of the relative movement of the recording medium, the one of the colors being printed in the most quantity in intermediate density areas with respect to a direction of the relative movement of the recording medium.

12. The image forming apparatus as defined in claim 11, wherein the intermediate density areas are areas in which a perceived density is substantially 0.8.

13. An ink ejection method for recording a color image onto a recording medium, comprising the steps of:
moving at once relatively the recording medium and a plurality of ink ejection heads corresponding to colors which form the color image;
ejecting respective inks of the colors from a plurality of nozzles comprised in the ink ejection heads toward the recording medium; and
setting dot arrangements for the respective colors on the recording medium according to a prescribed stripe pattern so that among absolute values of stripe angles formed by the inks of the colors with respect to a direction of the relative movement of the recording medium, the absolute value of the stripe angle formed by the ink of yellow is set to be a minimum.

14. The ink ejection method as defined in claim 13, wherein an angular difference between any pair of the stripe angles is 30° or greater.

15. An ink ejection method for recording a color image onto a recording medium, comprising the steps of:
moving at once relatively the recording medium and a plurality of ink ejection heads corresponding to colors which form the color image;
ejecting respective inks of the colors from a plurality of nozzles comprised in the ink ejection heads toward the recording medium; and
setting dot arrangements for the respective colors on the recording medium according to a prescribed stripe pattern so that among absolute values of stripe angles formed by the inks of the colors with respect to a direction of the relative movement of the recording medium, the absolute value of the stripe angle formed by the ink of magenta is set to be a maximum.

16. The ink ejection method as defined in claim 15, wherein an angular difference between any pair of the stripe angles is 30° or greater.

17. An ink ejection method for recording a color image onto a recording medium, comprising the steps of:
moving at once relatively the recording medium and a plurality of ink ejection heads corresponding to colors which form the color image;
ejecting respective inks of the colors from a plurality of nozzles comprised in the ink ejection heads toward the recording medium; and
setting dot arrangements for the respective colors on the recording medium according to a prescribed stripe pattern so that a stripe angle formed by one of the colors which is printed in the greatest quantity in intermediate density areas with respect to a relative direction of moving the recording medium at the moving step is set to be greater than stripe angles formed by others of the colors with respect to the relative direction of moving the recording medium at the moving step.

18. The image forming apparatus as defined in claim 17, wherein the intermediate density areas are areas in which a perceived density is substantially 0.8.
